(19) United States
(12) Patent Application Publication
(10) Pub. No.: US 2005/0026127 A1
(43) Pub. Date: Feb. 3, 2005

(54) Interactive talking products

(76) Inventor: Peter V. Cucinotta, Clearwater, FL (US)

Correspondence Address: PETER V. CUCINOTTA, PO BOX 171, CLEARWATER, FL, 33757, US

(21) Appl. No.: 10/896,777

(22) Filed: Jul. 22, 2004

Related U.S. Application Data
(60) Provisional application No. 60/489,233, filed on Jul. 22, 2003.

(51) Int. Cl. G09B 5/00; G09B 23/28

(52) U.S. Cl. 434/308

(57) ABSTRACT

A compound device, consisting of an electronic element or part and a variety of other items, which together comprise an invention, which will playback, prerecorded sounds when the ambient or direct light is interrupted. The Invention is not limited to the type of application, the venue, the objects employed or any other consideration if these four essential functions are present: Audio Playback Triggered Utilizing Photosensitivity Audio Programmable/Recordable By The User Self-Contained Power Supply Portable Various categories in which Interactive Talking Products can be used include, but is certainly not limited to: Security applications, novelties, amusements, messaging, advertising, point-of-purchase displays, shelf-talkers, toys, dolls, plaques, objects d'art, photographs, paintings, prints, figurines, interior and exterior dynamic displays and decorations.

### U.S. PATENT DOCUMENT REFERENCES CITED

| U.S. Pat. No.: | | | |
|---|---|---|---|
| 6,544,099 | April 2003 | Shafik | 446/404 |
| 4,675,519 | June 1987 | Price | 446/175 |
| 6,585,556 | July 2003 | Smirnov | 446/175 |
| 4,934,079 | June 1990 | Hoshi | 40/427 |
| 5,657,004 | August 1997 | Whitaker, et al | 340/815.45 |
| 4,912,457 | March 1990 | Ladd | 340/286.01 |

### BACKGROUND

The Invention is unique. Whereas, other talking dolls and various devices exist, they do not encompasses all four of the essential criteria mentioned several times in this document. Most ostensibly missing is the power to self-program the object as in the case of Talking Toy, Patent 3 U.S. Pat. No. 6,585,556. This is a wonderfully complex creation, which allows the toy to say things by a variety of different activation ways. However, the messages are pre-programmed on a computer chip and then can be recombined to create various messages, but always with the basic words/sounds pre-programmed. My Invention, however, allows the user very simply to put in whatever sound he wishes.

The examples of various talking devices are many—greeting cards that are activated when you open them (by a little button) advertising gadgets that say something to you when you press a button. There is an automatic photo enlarger . . . the ones that are seen in drug stores and department stores . . . that say something to you like “make some 8×10s of your favorite picture” or something. But, this is a preprogrammed message at the factory and is not programmable by the user.

U.S. Pat. No. 6,544,099 should be mentioned here, as this is an electronic device, which does meet all 4 criteria of my Invention. However, it is the electronic device, which is patented. There is no compound device claim made in this patent. While it specifies use with a punching bag, it is the electronic device that is patented, not a talking punching bag.

### OVERALL DESCRIPTION

This is a comprehensive utility application covering a wide range of products, including but not limited to the product called “Mirror, Mirror . . . ”. Further, “Mirror, Mirror . . . ” is described herein to be part of this patent, but also to serve as a representative example of other applications/products, which this patent covers.

This utility application is for a system, which allows a sound to be emitted when a playback device is triggered by a photosensitive sensor, which sensor has registered a change in existing light conditions, whether ambient or direct. This is not limited to a single product or object (such as “Mirror, Mirror . . . ”), but rather it encompasses any and all products or objects, which are capable of all of the following functions:
1. Audio Playback Triggered Utilizing Photosensitivity
2. Audio Programmable/Recordable By The User
3. Self-Contained Power Supply
4. Portable

If all of these elements are present, the Invention is then subject to this patent. By “Invention” is meant an electronic device plus an item, such as a mirror, combined. For the purposes of this document, the Invention is a compound device. And this application for patent is for a compound device having the above four attributes. Therefore, any mention in this document of the word “Invention” shall mean a compound device comprised of at least two elements.

### DRAWINGS AND THE ART

With respect to the drawings and descriptions of the Invention herein, it should be noted that anyone of the art could reproduce this particular example (the mirror) of the Invention rather easily. And, further, using the mirror as a representative example enables others of the art to easily envision creating the Invention in other forms.

### SPECIFIC DESCRIPTION

“Mirror, Mirror . . . ”, a specific Invention that this patent covers, shall be described here in detail both for its own patentability and to serve as an example for the wide variety of compound items that this patent covers.

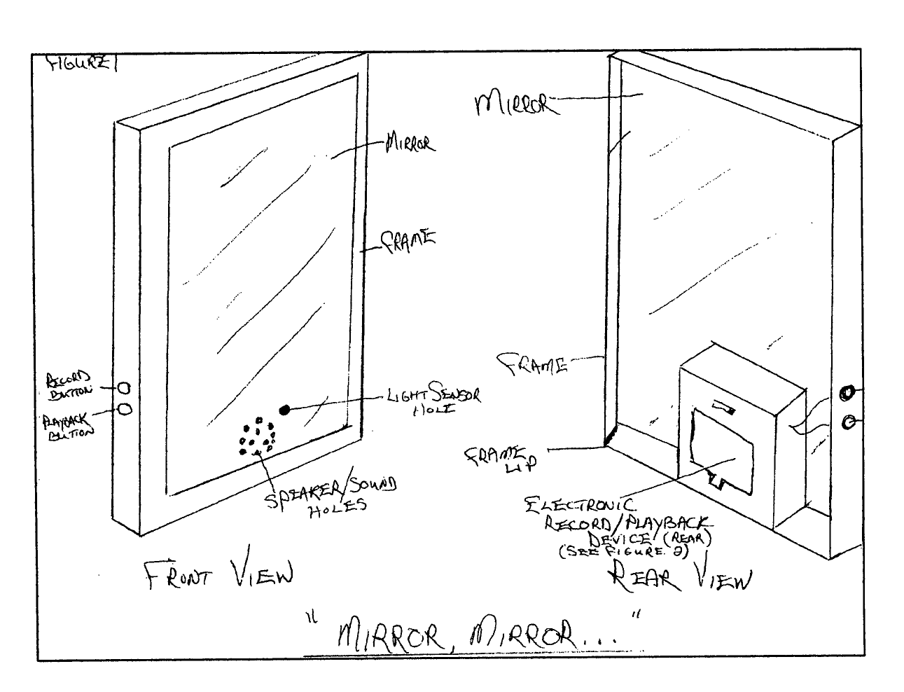

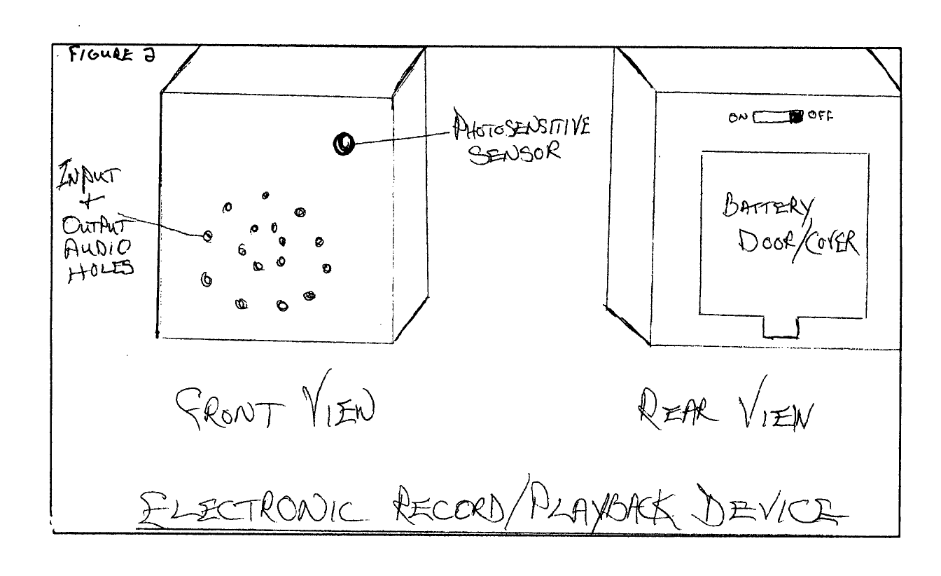

FIGS. 1 and 2 depict clearly the construct of a version of “Mirror, Mirror . . . ”. Just as “Mirror, Mirror . . . ” is a representative example of this comprehensive patent claim, the FIGS. 1 and 2 represent one type of construct of “Mirror, Mirror . . . ”. “Mirror, Mirror . . . ” may be of any dimensions, may be constructed of any materials, may or may not have a frame and may utilize any manufacture of appropriate electronic device that allows “Mirror, Mirror . . . ” to perform within the specified guidelines of:
Audio Playback Triggered Utilizing Photosensitivity
Audio Programmable/Recordable By The User
Self-Contained Power Supply
Portable.

So, utilizing “Mirror, Mirror . . . ” as a depicting example, here is a description of the workings of Interactive Talking Products.

The mirror, itself, has holes drilled through it for the passage of sound and light, which correlate with the holes of the electronic photosensitive audio recording/playback device.

The electronic device is powered by batteries and enables the Invention, by reason of being an integral part of the whole, to have a Self-Contained Power Supply and is not necessarily dependent on outside sources of power as supplied from through ordinary 110V wall sockets, or from generators or any other source.

By pressing a button (see FIG. 1), the user then speaks or in some way provides sound that passes through the hole in the mirror and thence into the audio microphone of the electronic device, thus creating a recording. Thus, the Invention is immediately and directly Audio Programmable/Recordable By The User without necessarily using other electronic equipment, such as a device for programming chips; or without necessarily utilizing electro-mechanical devices, such as a tape recorder or CD writer/burner. The way and the sound recorded is strictly up to the user, limited only to the recording capability of the Invention.

The user can then place the Invention wherever he wants, thus the Invention is extremely Portable. In the case of “Mirror, Mirror . . . ” it can be placed on the counter in the bathroom, or hung on a wall or placed on a dresser or on a desk or anywhere the user cares to place it. Other versions of the Invention, such as a frog figurine, could be placed by a door as a welcome device or in the garden. The point is the extreme portability of the Invention.

As someone (or something, such as an animal, moving car or anything else) passes in front of the Invention, the existing ambient or direct light, which is passing through a hole in the mirror and registering on a photosensitive eye/sensor in the electronic device, is changed/disturbed and this change is registered on the photosensitive eye/sensor. This sensor triggers the audio playback function of the user-recorded sound and “Good Morning Beautiful!” or whatever sound has been recorded is emitted from the electronic device through the mirror (or whatever object) holes. Thus the unified Invention has Audio Playback Triggered. Utilizing Photosensitivity.

This, then, is the nature and essence of the Invention. Once again it is stressed that the objects used, the materials used, the construction used, the various manufactures of electronic devices used are immaterial and irrelevant to the Invention. The Invention's only essential criteria are:
Audio Playback Triggered Utilizing Photosensitivity
Audio Programmable/Recordable By The User
Self-Contained Power Supply
Portable

Irrelevant items regarding the electronic device include: the electronic circuitry configuration, type number or size of battery(ies), the degree of photosensitivity, the distance of photosensitivity, the audio volume, the duration capability of recording, the duration capability of playback, the existence of an on/off switch (it could “always” be on), whether the recording is accomplished by button, switch or other means; also whether playback can also be triggered by button, switch or other means.

The electronic device merely has to contribute to the Invention to possess the above four essential qualities.

1. The Invention is a compound device consisting of two elements, one of which is electronic and the other(s) can be any item whatsoever. This compound device (the Invention) has following four attributes:
Audio Playback Triggered Utilizing Photosensitivity
Audio Programmable/Recordable By The User
Self-Contained Power Supply
Portable
The objects used, both electronic and other, have no bearing on the Invention, save only that combined they meet the above four criteria in 1.
The manner in which the objects in the compound device (which is the Invention) are attached to each other or configured are irrelevant as long as they fulfill the four criteria mentioned above in 1.
The electronic device used in the Invention can be of any manufacture, circuit design or configuration; utilizing whatever electronic art, whether computerized or not. The only restriction is that together with whatever other object in the Invention, it accomplishes the four criteria in 1.
The items or objects to be used in this compound device (the Invention), other than the electronic device, can be anything of any material whatsoever, and is not limited to mirrors, as the mirror described in this application is only a representative example of the Invention. The only criteria to be met, as an integral part of the Invention is that it allows the above four attributes to be met in 1.
The sounds recorded and played back, as mentioned in 1, can be of any sound, not just the human voice.
The distance of objects that may trigger the photosensitive aspect of the Invention, as mentioned in 1, have no bearing.
Portability as mentioned in the four criteria in 1, has the express meaning of “can be moved from one place to another” and will still operate. Size of the Invention, or whether it is affixed by the user, is immaterial.
Photosensitivity, as mentioned in 1, must in fact trigger playback. This is a criterion for the Invention. However, there may be buttons or other methods also to trigger playback. That is immaterial, as long as playback can at least be triggered by photosensitivity.
As mentioned in 1, the Invention must be able to be recorded on/programmable immediately by the user and without necessary intervention of other means, like an exterior tape recorder or computer. Though, these means can also be used.
The Invention must have a self-contained power supply, as mentioned in 1. It cannot be dependent for its operation on an external source of power such as 110V electricity from a wall socket, or electricity from a car lighter or other external means. It can be configured to use these or other methods in addition to its own power supply, however.

2. As described in 1, any objects and any electronic boxes can be employed as long as they together fulfill the four criteria mentioned in 1. Therefore, claim is made to any compound device that fulfills the four criteria in. These include, but are not limited to: talking-paintings, photographs, objects d'art, figurines, clocks, security devices, advertising devices, lamps, toys, amusement devices, dolls, mailboxes, household items.

3 Claim is made to specifically a talking mirror, such as the one described elsewhere in this application and as shown in FIGS. 1 and 2.
Such mirror, however, is not limited to the specifications described elsewhere in this document or in FIGS. 1 and 2. It can be of any size, material, with or without frame, with or without holes. It can reflect actual images or distorted, as in a “fun house” mirror. It can be a one-way mirror. The only criteria is that it reflects and is indeed a member of the Invention category, in that it fulfills the four criteria mentioned in 1. The electronic box/device used with it can be entirely different than what is pictured in FIGS. 1 and 2.
